(19) United States
(12) Patent Application Publication
(10) Pub. No.: US 2024/0053023 A1
(43) Pub. Date: Feb. 15, 2024

(54) COOKING DEVICE

(71) Applicant: YUNG SOON LIH FOOD MACHINE CO., LTD., Taichung City (TW)

(72) Inventor: JUI-TAI CHENG, Taichung City (TW)

(21) Appl. No.: 17/886,537

(22) Filed: Aug. 12, 2022

(51) Int. Cl. F24C 7/08; A47J 27/00; A47J 36/16; A47J 36/32; A47J 43/046

(52) U.S. Cl. CPC F24C 7/08; A47J 27/004; A47J 36/165; A47J 36/32; A47J 43/0465

(57) ABSTRACT

A cooking device is provided, including: a pot body, including a circumferential wall and a bottom wall which define a receiving space; a heating assembly, disposed around the circumferential wall; a stirring member, located in the receiving space and rotatably mounted to the bottom wall; a safety control assembly, including a first temperature sensor disposed on the bottom wall, a second temperature sensor disposed on the circumferential wall and a third temperature sensor disposed on the heating assembly; wherein temperatures detected respectively by the first, second and third temperature sensors are defined as first, second and third temperatures, respectively, and when the cooking device is on and a temperature difference between the first and second temperatures is larger than a reference temperature difference, the safety control assembly sends out a warming and control the heating assembly to stop operating.

### BACKGROUND OF THE INVENTION

### Field of the Invention

The present invention relates to a cooking device.

### Description of the Prior Art

In cooking, a cooking device is generally used to contain and cook materials (such as soy milk, rice milk). The pot body of the cooking device is heated so that the materials in the pot body can be well cooked. In order to prevent the materials from being deposited at the bottom and burning, a stirring member is usually installed at the bottom of the pot body for stirring the materials in the pot body. However, when the stirring member or the heating element malfunctions, the user is not aware of that problem externally, which will result in the burning of the materials at the bottom or result in bad flavor of the materials.

The present invention is, therefore, arisen to obviate or at least mitigate the above-mentioned disadvantages.

### SUMMARY OF THE INVENTION

The main object of the present invention is to provide a cooking device which can effectively detect the temperature thereinside and avoid malfunction of the cooking device, and can prevent accidents or overcooking.

To achieve the above and other objects, a cooking device is provided, including: a pot body, including a circumferential wall and a bottom wall, the circumferential wall and the bottom wall defining a receiving space; a heating assembly, disposed around the circumferential wall; a stirring member, located in the receiving space and rotatably mounted to the bottom wall; a safety control assembly, including a first temperature sensor, a second temperature sensor and a third temperature sensor, the first temperature sensor being disposed on the bottom wall to detect a temperature of the bottom wall, the second temperature sensor being disposed on the circumferential wall to detect a temperature of the circumferential wall, the third temperature sensor being disposed on the heating assembly to detect a temperature of the heating assembly; wherein the temperature detected by the first temperature sensor is defined as a first temperature, the temperature detected by the second temperature sensor is defined as a second temperature, and when the cooking device is on and a temperature difference between the first temperature and the second temperature is larger than a reference temperature difference, the safety control assembly sends out a warming and control the heating assembly to stop operating.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention; and

FIG. 2 is a cross-sectional view of a preferable embodiment of the present invention.

### DETAILED DESCRIPTION OF THE PREFERRED EMBODIMENTS

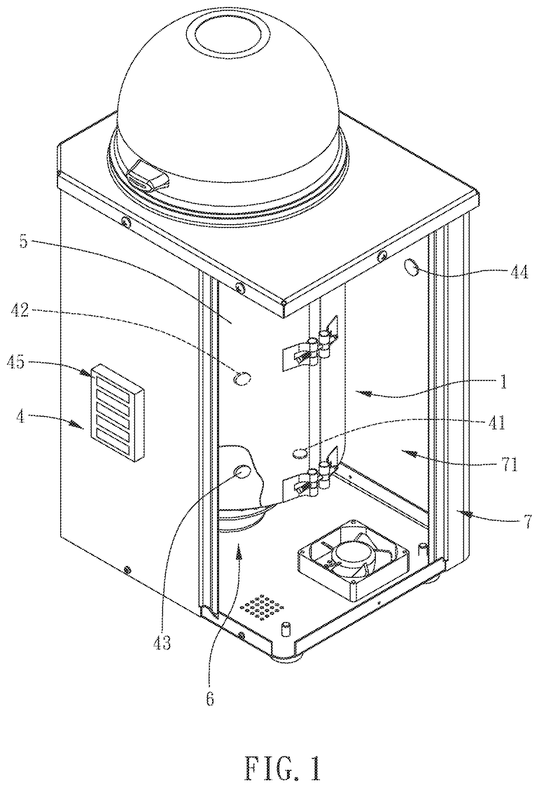

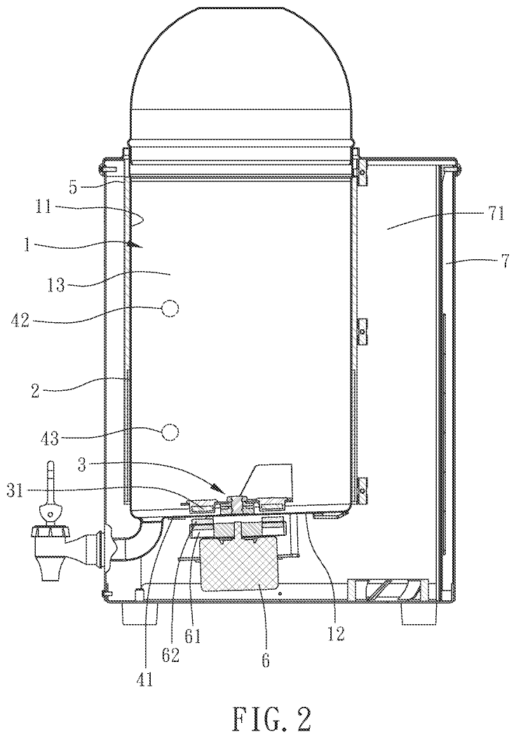

Please refer to FIGS. 1 to 2 for a preferable embodiment of the present invention. A cooking device of the present invention includes a pot body 1, a heating assembly 2, a stirring member 3 and a safety control assembly 4.

The pot body 1 includes a circumferential wall 11 and a bottom wall 12, and the circumferential wall 11 and the bottom wall 12 define a receiving space 13.

The heating assembly 2 is disposed around the circumferential wall 11.

The stirring member 3 is located in the receiving space 13 and rotatably mounted to the bottom wall 12, and configured for stirring the material (such as soy milk, rice milk) in the receiving space 13.

The safety control assembly 4 includes a first temperature sensor 41, a second temperature sensor 42 and a third temperature sensor 43, the first temperature sensor 41 is disposed on the bottom wall 12 to detect a temperature of the bottom wall 12, the second temperature sensor 42 is disposed on the circumferential wall 11 to detect a temperature of the circumferential wall 11, and the third temperature sensor 43 is disposed on the heating assembly 2 to detect a temperature of the heating assembly 2.

The temperature detected by the first temperature sensor 41 is defined as a first temperature, and the temperature detected by the second temperature sensor 42 is defined as a second temperature. When the cooking device is on and a temperature difference between the first temperature and the second temperature is larger than a reference temperature difference, the safety control assembly 4 sends out a warming and control the heating assembly 2 to stop operating. In this embodiment, the preset temperature difference is 6 degrees Celsius. Generally, the temperature of the bottom wall 12 and the temperature of the material near the bottom wall 12 are substantially the same, the temperature of the circumferential wall 11 and the material near the circumferential wall 11. When the temperature difference between the first temperature and the second temperature is larger than the preset temperature difference (6 degrees Celsius), it can be considered that the material in the pot body 1 is not well stirred by the stirring member 3 or that the heating power of the heating assembly 2 is too high, which can warm the user to observe the third temperature to check the operation of the heating assembly 2. As such, it is effective to detect the fault of the cooking device and is safe in use.

Specifically, the heating assembly 2 is disposed around a lower portion of the circumferential wall 11 adjacent to the bottom wall 12, the heating assembly 2 further includes an insulation layer 5, and the insulation layer 5 is disposed around the heating assembly 2 and the circumferential wall 11 for reducing the heat loss. In this embodiment, the second temperature sensor 42 is disposed between an upper portion of the circumferential wall 11 and the insulation layer 5, which can accurately detect the temperature of the circumferential wall 11 without affection of the heating assembly 2; the third temperature sensor 43 is disposed between the heating assembly 2 and the insulation layer 5, which can accurately detect the temperature of the heating assembly 2 without affection of the circumferential wall 11.

Specifically, the cooking device further includes a motor assembly 6, the motor assembly 6 is located outside the pot body 1 and corresponds to the bottom wall 12, the motor assembly 6 includes a rotatable member 61, the rotatable member 61 includes at least one first magnetic member 62, the stirring member 3 includes at least one second magnetic member 31, and each of the at least one first magnetic member 62 and one of the at least one second magnetic member 31 are magnetically attractive to each other so that the stirring member 3 can be driven to rotate with the rotatable member 61. As such, none of axle connected to the stirring member 3 is required to be disposed through the bottom wall 12, which avoids leakage of the material in the pot body.

When one of the first temperature and the second temperature is larger than 100 degrees Celsius, it is considered that the heating power of the heating assembly 2 is too high or that the material in the receiving space 13 is in sufficient, and the safety control assembly 4 sends out the warming and control the heating assembly 2 to stop operating.

Specifically, the cooking device further includes a case 7, the cooking device is received in the case 7, the case 7 and the pot body 1 forms an interval space 71, the safety control assembly 4 further includes a fourth temperature sensor 44, the fourth temperature sensor 44 is located in the interval space 71 or on the case 7, and a temperature detected by the fourth temperature sensor 44 is defined as a fourth temperature. When the fourth temperature is larger than 55 degrees Celsius, it is considered that the pot body 1 is overcooked, and the safety control assembly 4 sends out the warming and control the heating assembly 2 to stop operating. Similarly, when the third temperature is larger than 175 degrees Celsius, the safety control assembly 4 sends out the warming and control the heating assembly 2 to stop operating, whereby providing multiple assurances.

Additionally, the safety control assembly 4 is configured to monitor whether at least one of the first temperature and the second temperature changes linearly. When the at least one of the first temperature and the second temperature changes non-linearly (which is considered that the heating flux from the heating assembly 2 to the pot body is unstable), the safety control assembly 4 sends out the warming and control the heating assembly 2 to stop operating.

The safety control assembly 4 further includes a display device 45, and the display device 45 displays at least the first temperature, the second temperature, the third temperature and the fourth temperature, for immediate setting, control and/or management of the cooking device, accordingly.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cooking device, including:
a pot body, including a circumferential wall and a bottom wall, the circumferential wall and the bottom wall defining a receiving space;
a heating assembly, disposed around the circumferential wall;
a stirring member, located in the receiving space and rotatably mounted to the bottom wall;
a safety control assembly, including a first temperature sensor, a second temperature sensor and a third temperature sensor, the first temperature sensor being disposed on the bottom wall to detect a temperature of the bottom wall, the second temperature sensor being disposed on the circumferential wall to detect a temperature of the circumferential wall, the third temperature sensor being disposed on the heating assembly to detect a temperature of the heating assembly;
wherein the temperature detected by the first temperature sensor is defined as a first temperature, the temperature detected by the second temperature sensor is defined as a second temperature, and when the cooking device is on and a temperature difference between the first temperature and the second temperature is larger than a reference temperature difference, the safety control assembly sends out a warming and control the heating assembly to stop operating.

2. The cooking device of claim 1, wherein the heating assembly is disposed around a lower portion of the circumferential wall adjacent to the bottom wall, the heating assembly further includes an insulation layer, and the insulation layer is disposed around the heating assembly and the circumferential wall.

3. The cooking device of claim 2, wherein the second temperature sensor is disposed between an upper portion of the circumferential wall and the insulation layer, and the third temperature sensor is disposed between the heating assembly and the insulation layer.

4. The cooking device of claim 1, further including a motor assembly, wherein the motor assembly is located outside the pot body and corresponds to the bottom wall, the motor assembly includes a rotatable member, the rotatable member includes at least one first magnetic member, the stirring member includes at least one second magnetic member, and each of the at least one first magnetic member and one of the at least one second magnetic member are magnetically attractive to each other so that the stirring member can be driven to rotate with the rotatable member.

5. The cooking device of claim 1, wherein the preset temperature difference is 6 degrees Celsius.

6. The cooking device of claim 1, wherein when one of the first temperature and the second temperature is larger than 100 degrees Celsius, the safety control assembly sends out the warming and control the heating assembly to stop operating.

7. The cooking device of claim 1, further includes a case, wherein the pot body is received in the case, the case and the pot body forms a interval space therebetween, the safety control assembly further includes a fourth temperature sensor, the fourth temperature sensor is located in the interval space or on the case, a temperature detected by the fourth temperature sensor is defined as a fourth temperature, and when the fourth temperature is larger than 55 degrees Celsius, the safety control assembly sends out the warming and control the heating assembly to stop operating.

8. The cooking device of claim 1, wherein when the third temperature is larger than 175 degrees Celsius, the safety control assembly sends out the warming and control the heating assembly to stop operating.

9. The cooking device of claim 1, wherein the safety control assembly is configured to monitor whether at least one of the first temperature and the second temperature changes linearly or not, and when the at least one of the first temperature and the second temperature changes non-linearly, the safety control assembly sends out the warming and control the heating assembly to stop operating.

10. The cooking device of claim 3, further including a motor assembly, wherein the motor assembly is located outside the pot body and corresponds to the bottom wall, the motor assembly includes a rotatable member, the rotatable member includes at least one first magnetic member, the stirring member includes at least one second magnetic member, and each of the at least one first magnetic member and one of the at least one second magnetic member are magnetically attractive to each other so that the stirring member can be driven to rotate with the rotatable member; the preset temperature difference is 6 degrees Celsius; when one of the first temperature and the second temperature is larger than 100 degrees Celsius, the safety control assembly sends out the warming and control the heating assembly to stop operating; the cooking device further includes a case, the pot body is received in the case, the case and the pot body forms a interval space therebetween, the safety control assembly further includes a fourth temperature sensor, the fourth temperature sensor is located in the interval space or on the case, a temperature detected by the fourth temperature sensor is defined as a fourth temperature, and when the fourth temperature is larger than 55 degrees Celsius, the safety control assembly sends out the warming and control the heating assembly to stop operating; when the third temperature is larger than 175 degrees Celsius, the safety control assembly sends out the warming and control the heating assembly to stop operating; the safety control assembly is configured to monitor whether at least one of the first temperature and the second temperature changes linearly or not, and when the at least one of the first temperature and the second temperature changes non-linearly, the safety control assembly sends out the warming and control the heating assembly to stop operating; the safety control assembly further includes a display device, and the display device displays at least the first temperature, the second temperature, the third temperature and the fourth temperature.
